(19) United States
(12) Patent Application Publication
(10) Pub. No.: US 2006/0224886 A1
(43) Pub. Date: Oct. 5, 2006

(54) System for finding potential origins of spoofed internet protocol attack traffic

(76) Inventors: Donald N. Cohen, Los Angeles, CA (US); Krishnamurthy Narayanaswamy, Los Angeles, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/099,181

(22) Filed: Apr. 5, 2005

(51) Int. Cl. H04L 9/00

(52) U.S. Cl. 713/154

(57) ABSTRACT

The invention computes approximate origins of data packets transmitted over the Internet. Law enforcement agencies and network operators can use it to assign responsibility for observed Internet activities. The invention uses a small number of cooperative locations (incoming links on routers or switches) to provide link identification data: whether a packet or did or did not traverse that location. The system uses these cooperative places to generate the link signature of a data packet—which places observed and did not observe the packet. Potential origin locations are divided into blocks that have the same link signatures to given destination locations. The blocks are used to generate reverse routing data, potential source addresses for different link signatures. Variations of the invention store relevant link identification and reverse routing data to find the origins of past packets or to compute the origins of packets from partial information about packets of interest.

### FIELD OF INVENTION

The invention pertains to network data transmission monitoring. More particularly, the invention relates to systems for identifying the source of identified data packets based upon incomplete information regarding packet routing.

### BACKGROUND OF THE INVENTION

Those who would mount attacks on Internet websites or addresses have the ability to falsify the source addresses (origins) of the packets they send in their attacks. There is, therefore, a need for a reliable attribution method to identify the addresses of machines that might actually have originated an attack packet once it arrives at a victim site. As all the machines connected to a hub in a Local Area Network (LAN) may be indistinguishable from one another as the potential origins of a packet, we may be only able to determine a (preferably small) set of addresses that contain the actual origin. This result, however, may be very useful to those attempting to track the origin of an identified data packet.

A variation of this problem is to identify the IP packet from an incomplete description of its properties, and then find the true origin of that packet. This is a useful variation of the problem in practice because it may not always be reasonable to expect trackers to have the actual IP packet. It is far more likely that a tracker will know specific properties of the attack. For example, a tracker might be expected to know information such as the time of the attack, the IP address of the machine that was the victim, perhaps the port of the machine and the type of packet (protocol) involved. The present invention attempts to solve these problems by development of a series cooperating information sources that can reliably report whether or not an identified data packet has passed through the source at a point in time. Various types of systems have been developed for identifying the origin of data streams under a variety of differing conditions, incorporating a number of different technologies.

U.S. Pat. No. 6,822,971 issued to Mikkonen discloses a module, and associated method, that is engageable with a data terminal. The module includes a storage element for storing an identifier address, used to identify the origin of a packet of data. The module can be released out of positioning at a first data terminal and thereafter utilized at a second data terminal. Thereby, mobility of communications is increased as a user of successive data terminals can identify each successive data terminal with the same identifier.

U.S. Pat. No. 5,798,706 issued to Kraemer et al., describes a back door packet communication between a workstation on a network and a device outside the network that is identified by detecting packets that are associated with communication involving devices outside the network, and identifying packets, among those detected packets, that are being sent or received by a device that is not authorized for communication with devices outside the network.

U.S. Pat. No. 6,279,113, issued to Vaidya discloses a signature based dynamic network intrusion detection system (IDS) includes attack signature profiles which are descriptive of characteristics of known network security violations. The attack signature profiles are organized into sets of attack signature profiles according to security requirements of network objects on a network. Each network object is assigned a set of attack signature profiles which is stored in a signature profile memory together with association data indicative of which sets of attack signature profiles correspond to which network objects. A monitoring device monitors network traffic for data addressed to the network objects. Upon detecting a data packet addressed to one of the network objects, packet information is extracted from the data packet. The extracted information is utilized to obtain a set of attack signature profiles corresponding to the network object based on the association data. A virtual processor executes instructions associated with attack signature profiles to determine if the packet is associated with a known network security violation. An attack signature profile generator is utilized to generate additional attack signature profiles configured for processing by the virtual processor in the absence of any corresponding modification of the virtual processor.

U.S. Pat. No. 6,088,804 issued to Hill et al. describes a dynamic network security system that responds to security attacks on a computer network having a multiplicity of computer nodes. The security system includes a plurality of security agents that concurrently detect occurrences of security events on associated computer nodes. A processor processes the security events that are received from the security agents to form an attack signature of the attack . A network status display displays multi-dimensional attack status information representing the attack in a two dimensional image to indicate the overall nature and severity of the attack. The network status display also includes a list of recommended actions for mitigating the attack. The security system is adapted to respond to a subsequent attack that has a subsequent signature most closely resembling the attack signature.

U.S. Pat. No. 6,301,668 to Gleichauf et al. discloses a method and system for adaptive network security using network vulnerability assessment is disclosed. The method comprises directing a request onto a network. A response to the request is assessed to discover network information. A plurality of analysis tasks are prioritized based upon the network information. The plurality of analysis tasks are to be performed on monitored network data traffic in order to identify attacks upon the network.

The primary objective of the present invention is to provide a system that will allow users to identify the source of an identified data packet or packet stream at any point in time. In this way, a source of unwanted packets that are potentially harmful to a given destination may be prevented from sending the unwanted packets or the packet stream avoided. A secondary objective is to develop the system as a service utility that can utilize information obtained from a cooperating community to broaden and strengthen the integrity of the network in which it operates and to make it more difficult for untrusted sources to send unwanted data packets to destination sites. A further objective is to provide these capabilities and services without requiring modifications to existing router hardware.

### SUMMARY OF THE INVENTION

The present invention addresses many of the deficiencies of prior packet source identification systems and satisfies all of the objectives described above.

(1) A system for identifying a set of potential origins of Internet Protocol data packets on a network includes a plurality of cooperating network locations. The cooperating locations provide information as to whether an identified data packet did or did not pass through the location at an identified point in time. A link signature is provided for each of the identified data packets. The link signature is developed from information provided by the cooperating locations and includes a series of first predetermined values for each cooperating location through which the packet did pass and a series of second predetermined values for each cooperating location through which the packet did not pass. A table of origins is provided. The table includes identified destination locations, unions of all link signatures matching partial data packet information available for the identified data packet and origin locations consistent with the link signatures. When a system user supplies a destination location and partial data packet information regarding an identified data packet, the system will identify the set of possible origins for the data packet.

(2) In a variant of the invention, the system includes a system for dividing locations into blocks. The blocks include locations that have identical link signatures for routing a packet to any location from another identified block at the identified point in time. A reverse routing table is provided. The table includes link signatures identifying at least one valid routing between selected locations in each destination/source pair of blocks in the network for the identified point in time. When the locations in the network are divided into the blocks, the set of possible origins of identified packets may be more easily determined for very large networks.

(3) In another variant, the table of origins includes blocks having identified destination locations within them, unions of all link signatures matching partial data packet information available for the identified data packet and origin locations consistent with the link signatures in the reverse routing table.

(4) In still another variant, the cooperating network locations include incoming links to routers or switches on the network.

(5) In yet another variant, the first predetermined values are either of “1” and “true” and the second predetermined values are either of “0” and “false.”

(6) In a further variant, the link signature for each identified data packet is gathered and maintained over a period of time, thereby permitting historical inquiries of the system.

(7) In still a further variant, the link signatures identifying all possible valid routings between a selected cooperating location in each destination/source pair of blocks in the network for the reverse routing table are gathered using a system that includes an identified destination location in each block, an identified responding source location in each block and a probe packet sent to responding locations in each of the source blocks. The probe packet causes the source blocks to send an identifiable response packet to each of the destination locations in the destination blocks. A link signature for each destination/source pair of locations is derived from information returned by the identifiable response to the probe packet. An assignment is made of each of the derived link signatures as link signatures indicating valid routing to all destination locations within the block from all potential source locations within any other block. The link signature derived from the identifiable response to the probe packet is recognized as is one of those that could be observed for packets forwarded from the given source block to the given destination block at a given point in time.

(8) In yet a further variant, the link signatures in the reverse routing table are gathered and maintained over a period of time, thereby permitting historical inquiries of the table.

(9) In another variant, definitions of the blocks are updated as new link signature information related to locations within the blocks is received, thereby maintaining the blocks as groups of locations having identical link signatures for routing a packet to an identified location at the identified point in time.

(10) In still another variant, tools are provided for collecting and storing information at cooperating locations related to data packets passing through the cooperating locations over identified periods of time. The information includes at least link signature and routing information related to the packets, thereby providing further means for identifying potential origins for data packets based upon partial packet information.

(11) A method for identifying a set of potential origins of Internet Protocol data packets on a network includes the following steps. Identifying a plurality of cooperating network locations. The cooperating locations provide information as to whether an identified data packet did or did not pass through the cooperating location at an identified point in time. Creating a link signature for each of the identified data packets. The link signatures are developed from information provided by the cooperating locations and include a series of first predetermined values for each cooperating location through which the packet did pass and a series of second predetermined values for each cooperating location through which the packet did not pass. Developing a table of origins. The table includes identified destination locations, unions of all link signatures matching partial data packet information available for the identified data packets and origin locations consistent with the link signatures. When a system user supplies a destination location and partial data packet information regarding an identified data packet, the system will identify the set of possible origins for the data packet.

(12) A variant of the invention, includes the further steps of dividing locations into blocks. The blocks comprise locations that have identical link signatures for routing a packet to any location from another identified block at the identified point in time. Creating a reverse routing table. The table includes link signatures identifying at least one valid routing between selected locations in each destination/source pair of blocks in the network for the identified point in time. When the locations in the network are divided into the blocks, the set of possible origins of identified packets may be more easily determined for very large networks.

(13) Another variant includes the step of developing a table of origins which comprises blocks having identified destination locations within them, unions of all link signatures matching partial data packet information available for the identified data packet and origin locations consistent with the link signatures in the reverse routing table.

(14) In yet another variant, the cooperating network locations comprise incoming links to routers or switches on the network.

(15) In still another variant, the first predetermined values are either of “1” and “true” and the second predetermined values are either of “0” and “false.”

(16) A further variant includes the further step of gathering and maintaining the link signature for each identified data packet over a period of time, thereby permitting historical inquiries of the system.

(17) Still a further variant, the method of developing link signatures identifying all possible valid routes between a selected cooperating location in each destination/source pair of blocks in the network for the reverse routing table includes the further steps of identifying a destination location in each block. Identifying a responding source location in each block. Sending a probe packet to responding locations in each of the source blocks causing the source blocks to send an identifiable response packet to each of the destination locations in the destination blocks. Creating a link signature for each for each destination/source pair of locations derived from information returned by the identifiable response to the probe packet. Making an assignment of each the derived link signature as link signatures indicating valid routing for all destination locations within the block to all potential source locations within any other block. The link signature derived from the identifiable response to the probe packet is recognized as is one of those that could be observed for packets forwarded from the given source block to the given destination block at a given point in time.

(18) Yet a further variant of the invention includes the further steps of gathering and maintaining the link signatures in the reverse routing table over a period of time, thereby permitting historical inquiries of the table.

(19) Another variant of the method includes the further step of updating definitions of the blocks as new link signature information related to cooperating locations within the blocks is received, thereby maintaining the blocks as groups of locations having identical link signatures for routing a packet to an identified location at the identified point in time.

(20) A final variant of the method includes the further step of collecting and storing information at cooperating locations related to data packets passing through the cooperating locations over identified periods of time, the information includes at least link signature and routing information related to the packets, thereby providing further means for identifying potential origins for data packets based upon partial packet information.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a schematic view of a first embodiment of the invention illustrating a network comprising origin and destination locations, cooperating and non-cooperating network locations, identified packets and network links;

FIG. 2 is a table illustrating link signatures for identified data packets derived from cooperating locations;

FIG. 3 is a table of origins for various destinations and link signatures for valid routings between them found for identified packets;

FIG. 4 is a table of origins for blocks of network locations illustrating link signatures for valid routings between destination and origin blocks found for identified packets;

FIG. 5 is a reverse routing table illustrating link signatures for valid routings between destination blocks and source blocks within the network; and

FIG. 6 is a schematic view of a system for link signature generation using probe packets sent through cooperating and non-cooperating network locations and response packets returning a valid routing from the possible origin location back to the destination location.

### DETAILED DESCRIPTION OF THE PREFERRED EMBODIMENT

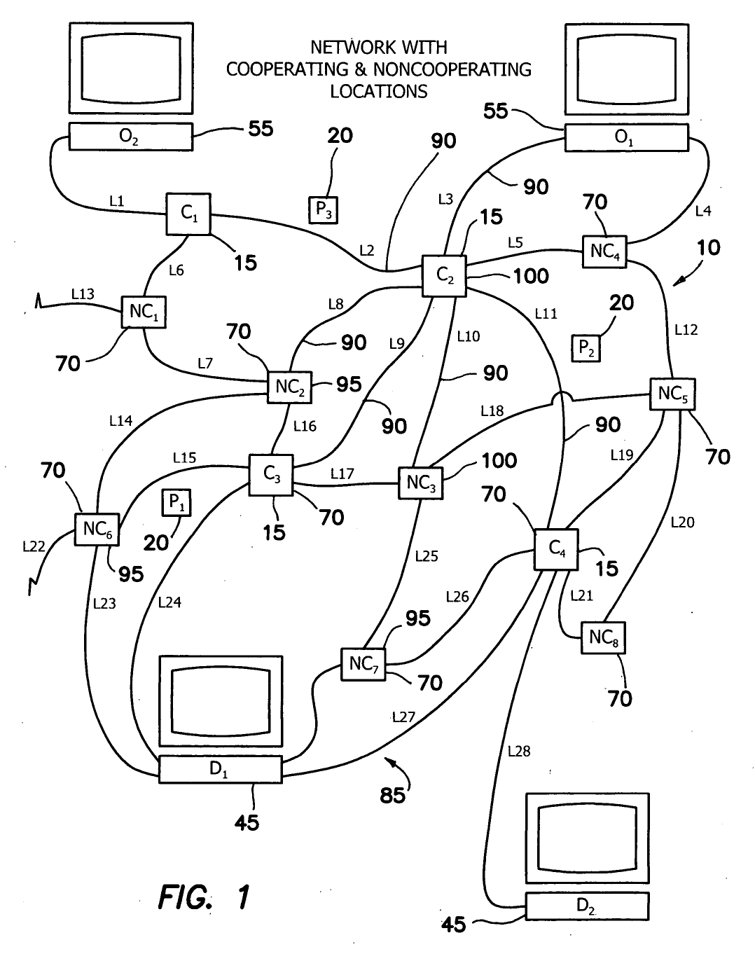

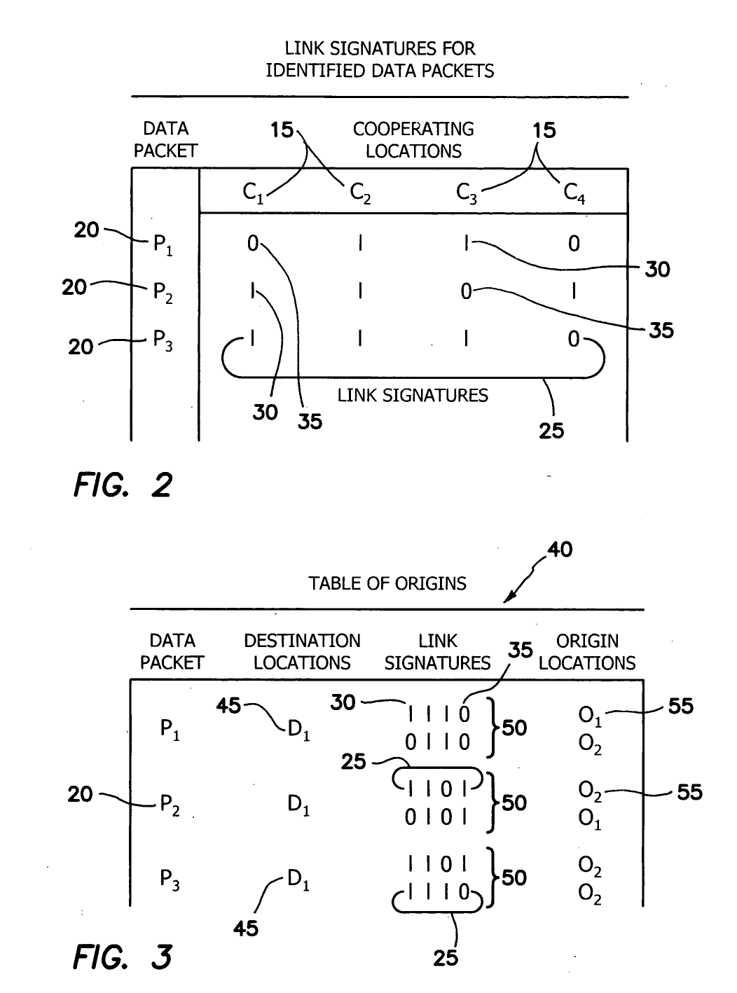

(1) FIGS. 1-6 illustrate a system 10 for identifying a set of potential origins 55 of Internet Protocol data packets 20 on a network 85 providing the desired features that may be constructed from the following components. A plurality of cooperating network locations 15 is determined. The cooperating locations 15 provide information as to whether an identified data packet 20 did or did not pass through the location 15 at an identified point in time. A link signature 25 is provided for each of the identified data packets 20. As illustrated in FIG. 2, the link signature 25 is developed from information provided by the cooperating locations 15 and includes a series of first predetermined values 30 for each cooperating location 15 through which the packet 20 did pass and a series of second predetermined values 35 for each cooperating location 15 through which the packet 20 did not pass. As illustrated in FIG. 3, a table of origins 40 is provided. The table 40 includes identified destination locations 45, unions 50 of all link signatures 25 matching partial data packet information available for the identified data packet 20 and origin locations 55 consistent with the link signatures 25. When a system user supplies a destination location 45 and partial data packet information regarding an identified data packet 20, the system 10 will identify the set of possible origins 55 for the data packet 20.

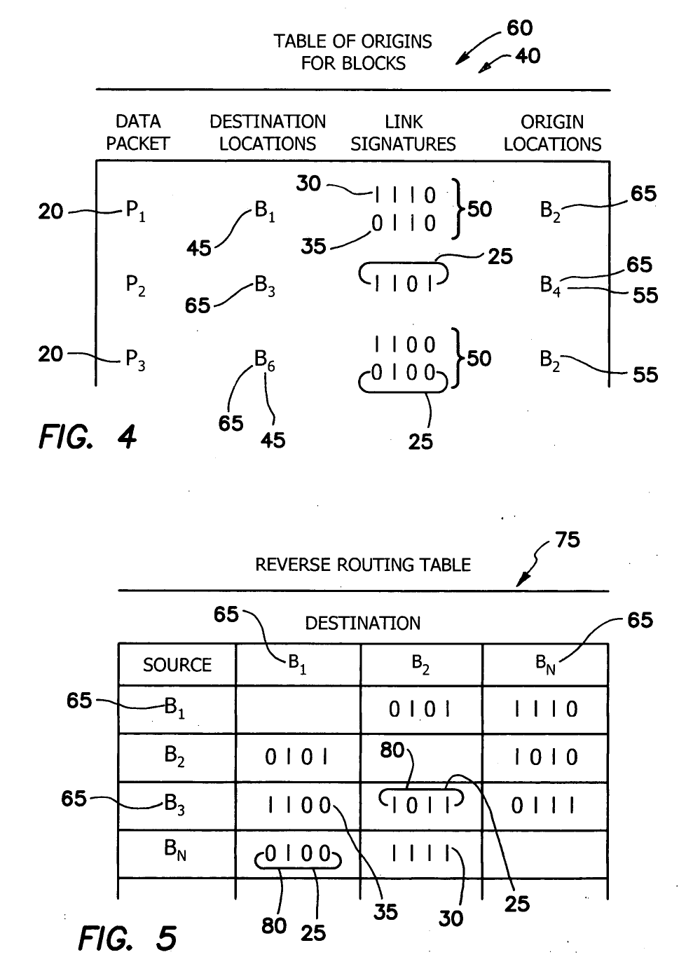

(2) In a variant of the invention, as illustrated in FIG. 4, the system 10 includes a system 60 for dividing locations 70 into blocks 65. The blocks 65 include locations 70 that have identical link signatures 25 for routing a packet 20 to any location 70 from another identified block 65 at the identified point in time. As illustrated in FIG. 5, a reverse routing table 75 is provided. The table 75 includes link signatures 25 identifying at least one valid routing 80 between selected locations 70 in each destination/source pair of blocks 65 in the network 85 for the identified point in time. When the locations 70 in the network 85 are divided into the blocks 65, the set of possible origins or source locations 55 of identified packets 20 may be more easily determined for very large networks 85.

(3) In another variant, as illustrated in FIG. 4, the table of origins 40 includes blocks 65 having identified destination locations 45 within them, unions 50 of all link signatures 25 matching partial data packet information available for the identified data packet 20 and origin locations 55 consistent with the link signatures 25 in the reverse routing table 75.

(4) In still another variant, as illustrated in FIG. 1, the cooperating network locations 15 include incoming links 90 to routers 95 or switches 100 on the network 85.

(5) In yet another variant, as illustrated in FIGS. 2-5, the first predetermined values 30 are either of “1” and “true” and the second predetermined values 35 are either of “0” and “false.”

(6) In a further variant, the link signature 25 for each identified data packet 20 is gathered and maintained over a period of time, thereby permitting historical inquiries of the system.

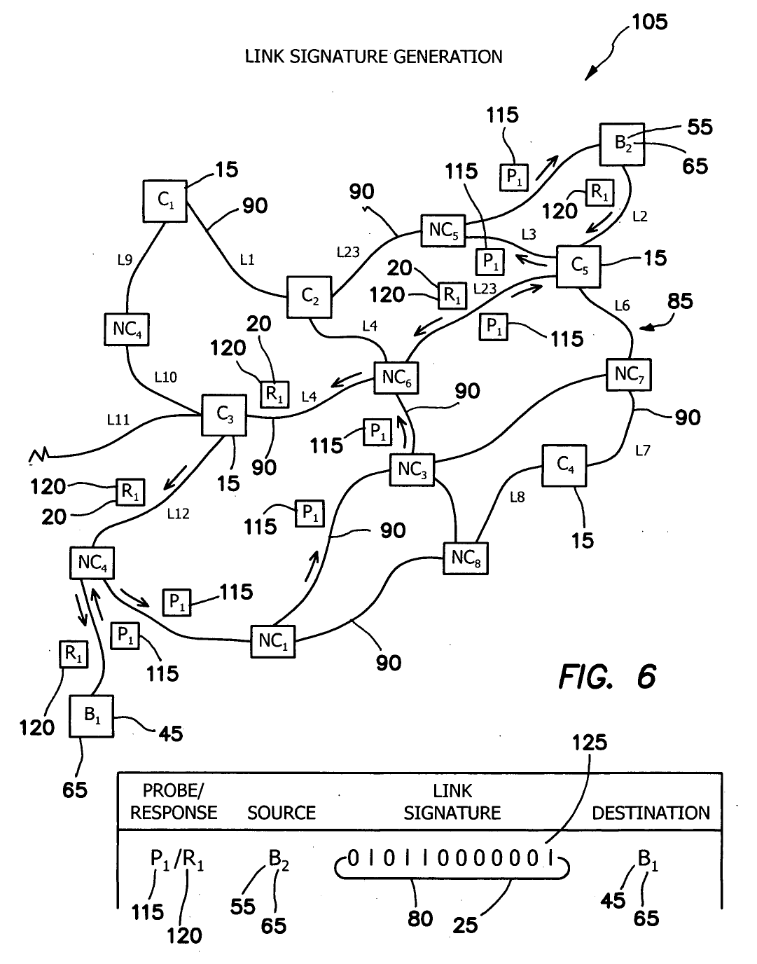

(7) In still a further variant, as illustrated in FIG. 6, the link signatures 25 identifying all possible valid routings 80 between a selected cooperating location 15 in each destination/source pair of blocks 65 in the network 85 for the reverse routing table 75 are gathered using a system 105 that includes an identified destination location 45 in each block 65, an identified responding source location 55 in each block 65 and a probe packet 115 sent to responding locations 55 in each of the source blocks 65. The probe packet 115 causes the source blocks 65 to send an identifiable response packet 120 to each of the destination locations 45 in the destination blocks 65. A link signature 25 for each destination/source pair of locations 70 is derived from information returned by the identifiable response 120 to the probe packet 115. An assignment 125 is made of each of the derived link signatures 25 as link signatures 25 indicating valid routing 80 to all destination locations 45 within the block 65 from all potential source locations 55 within any other block 65. The link signature 25 derived from the identifiable response 120 to the probe packet 115 is recognized as is one of those that could be observed for packets 20 forwarded from the given source block 65 to the given destination block 65 at a given point in time.

(8) In yet a further variant, as illustrated in FIG. 5, the link signatures 25 in the reverse routing table 75 are gathered and maintained over a period of time, thereby permitting historical inquiries of the table.

(9) In another variant, as illustrated in FIG. 4, definitions of the blocks 65 are updated as new link signature 25 information related to locations 70 within the blocks 65 is received, thereby maintaining the blocks 65 as groups of locations 70 having identical link signatures 25 for routing a packet 20 to an identified location 70 at the identified point in time.

(10) In still another variant, tools (not shown) are provided for collecting and storing information at cooperating locations 15 related to data packets 20 passing through the cooperating locations 15 over identified periods of time. The information includes at least link signature 25 and routing information related to the packets 20, thereby providing further means for identifying potential origins 55 for data packets 20 based upon partial packet information.

(11) FIGS. 1-6 illustrate a method for identifying a set of potential origins or source locations 55 of Internet Protocol data packets 20 on a network 85 includes the following steps. Identifying a plurality of cooperating network locations 15. The cooperating locations 15 provide information as to whether an identified data packet 20 did or did not pass through the cooperating location 15 at an identified point in time. Creating a link signature 25 for each of the identified data packets 20. As illustrated in FIG. 2, the link signatures 25 are developed from information provided by the cooperating locations 15 and include a series of first predetermined values 30 for each cooperating location 15 through which the packet 20 did pass and a series of second predetermined values 35 for each cooperating location 15 through which the packet 20 did not pass. Developing a table of origins 40, as illustrated in FIG. 3. The table 40 includes identified destination locations 45, unions 50 of all link signatures 25 matching partial data packet information available for the identified data packets 20 and origin locations 55 consistent with the link signatures 25. When a system user supplies a destination location 45 and partial data packet information regarding an identified data packet 20, the system 10 will identify the set of possible origins 55 for the data packet 20.

(12) A variant of the invention, as illustrated in FIG. 4, includes the further steps of dividing locations 70 into blocks 65. The blocks 65 comprise locations 70 that have identical link signatures 25 for routing a packet 20 to any location 70 from another identified block 65 at the identified point in time. Creating a reverse routing table 75 as illustrated in FIG. 5. The table 75 includes link signatures 25 identifying at least one valid routing 80 between selected locations 70 in each destination/source pair of blocks 65 in the network 85 for the identified point in time. When the locations 70 in the network 85 are divided into the blocks 65, the set of possible origins 55 of identified packets 20 may be more easily determined for very large networks 85.

(13) Another variant, as illustrated in FIG. 4, includes the step of developing a table of origins 40 which comprises blocks 65 having identified destination locations 45 within them, unions 50 of all link signatures 25 matching partial data packet information available for the identified data packet 20 and origin locations 55 consistent with the link signatures 25 in the reverse routing table 75.

(14) In yet another variant, as illustrated in FIG. 1, the cooperating network locations 15 comprise incoming links 90 to routers 95 or switches 100 on the network 85.

(15) In still another variant, as illustrated in FIGS. 2-5, the first predetermined values 30 are either of “1” and “true” and the second predetermined values 35 are either of “0” and “false.”

(16) A further variant includes the further step of gathering and maintaining the link signature 25 for each identified data packet 20 over a period of time, thereby permitting historical inquiries of the system.

(17) Still a further variant, as illustrated in FIG. 6, the method of developing link signatures 25 identifying all possible valid routings 80 between a selected cooperating location 15 in each destination/source pair of blocks 65 in the network 85 for the reverse routing table 75 includes the further steps of identifying a destination location 45 in each block 65. Identifying a responding source location 55 in each block 65. Sending a probe packet 115 to responding locations 55 in each of the source blocks 65 causing the source blocks 65 to send an identifiable response packet 120 to each of the destination locations 45 in the destination blocks 65. Creating a link signature 25 for each for each destination/source pair of locations 70 derived from information returned by the identifiable response 120 to the probe packet 115. Making an assignment 125 of each the derived link signatures 25 as link signatures 25 indicating valid routing 80 for all destination locations 45 within the block 65 to all potential source locations 55 within any other block 65. The link signature 25 derived from the identifiable response 120 to the probe packet 115 is recognized as is one of those that could be observed for packets 20 forwarded from the given source block 65 to the given destination block 65 at a given point in time.

(18) Yet a further variant of the invention, as illustrated in FIG. 5, includes the further steps of gathering and maintaining the link signatures 25 in the reverse routing table 75 over a period of time, thereby permitting historical inquiries of the table.

(19) Another variant of the method, as illustrated in FIG. 4, includes the further step of updating definitions of the blocks 65 as new link signature 25 information related to cooperating locations 15 within the blocks 65 is received, thereby maintaining the blocks 65 as groups of locations 70 having identical link signatures 25 for routing a packet 20 to an identified location 70 at the identified point in time.

(20) A final variant of the method includes the further step of collecting and storing information at cooperating locations 15 related to data packets 20 passing through the cooperating locations 15 over identified periods of time, the information includes at least link signature 25 and routing information related to the packets 20, thereby providing further means for identifying potential origins 55 for data packets 20 based upon partial packet information.

The system for finding potential origins of spoofed Internet Protocol attack traffic 10 has been described with reference to particular embodiments. Other modifications and enhancements can be made without departing from the spirit and scope of the claims that follow.

1. A system for identifying a set of potential origins of Internet Protocol data packets on a network, said system comprising:
a plurality of cooperating network locations, said cooperating locations providing information as to whether an identified data packet did or did not pass through said location at an identified point in time;
a link signature for each of said identified data packets, said link signature developed from information provided by said cooperating locations comprising a series of first predetermined values for each cooperating location through which said packet did pass and a series of second predetermined values for each cooperating location through which said packet did not pass;
a table of origins, said table comprising identified destination locations, unions of all link signatures matching partial data packet information available for said identified data packet and origin locations consistent with said link signatures; and
whereby, when a system user supplies a destination location and partial data packet information regarding an identified data packet, said system will identify the set of possible origins for said data packet.

2. The system for identifying a set of potential origins of Internet Protocol data packets on a network, as described in claim 1, further comprising:
a system for dividing locations into blocks, where such blocks comprise locations that have identical link signatures for routing a packet to any location from another identified block at said identified point in time;
a reverse routing table, said table comprising link signatures identifying at least one valid routing between selected locations in each destination/source pair of blocks in said network for said identified point in time; and
whereby, when said locations in said network are divided into said blocks, the set of possible origins of identified packets may be more easily determined for very large networks.

3. The system for identifying a set of potential origins of Internet Protocol data packets on a network, as described in claim 2, wherein said table of origins comprises blocks having identified destination locations within them, unions of all link signatures matching partial data packet information available for said identified data packet and origin locations consistent with said link signatures in said reverse routing table.

4. The system for identifying a set of potential origins of Internet Protocol data packets on a network, as described in claim 1, wherein said cooperating network locations comprise incoming links to routers or switches on said network.

5. The system for identifying a set of potential origins of Internet Protocol data packets on a network, as described in claim 1, wherein said first predetermined values are either of “1” and “true” and said second predetermined values are either of “0” and “false.”

6. The system for identifying a set of potential origins of Internet Protocol data packets on a network, as described in claim 1, wherein said link signature for each identified data packet is gathered and maintained over a period of time, thereby permitting historical inquiries of said system.

7. The system for identifying a set of potential origins of Internet Protocol data packets on a network, as described in claim 2, wherein said link signatures identifying all possible valid routings between a selected cooperating location in each destination/source pair of blocks in said network for said reverse routing table are gathered using a system comprising:
an identified destination location in each block;
an identified responding source location in each block;
a probe packet sent to responding locations in each of said source blocks causing said source blocks to send an identifiable response packet to each of said destination locations in said destination blocks;
a link signature for each destination/source pair of locations derived from information returned by said identifiable response to said probe packet;
an assignment of each of said derived link signatures as link signatures indicating valid routing to all destination locations within said block from all potential source locations within any other block; and
whereby, the link signature derived from said identifiable response to said probe packet is recognized as being one of those that could be observed for packets forwarded from said given source block to said given destination block at a given point in time.

8. The system for identifying a set of potential origins of Internet Protocol data packets on a network, as described in claim 2, wherein said link signatures in said reverse routing table are gathered and maintained over a period of time, thereby permitting historical inquiries of said table.

9. The system for identifying a set of potential origins of Internet Protocol data packets on a network, as described in claim 2, wherein definitions of said blocks are updated as new link signature information related to locations within said blocks is received, thereby maintaining said blocks as groups of locations having identical link signatures for routing a packet to an identified location at said identified point in time.

10. The system for identifying a set of potential origins of Internet Protocol attack traffic data packets on a network, as described in claim 1, further comprising tools for collecting and storing information at cooperating locations related to data packets passing through said cooperating locations over identified periods of time, said information comprising at least link signature and routing information related to said packets, thereby providing further means for identifying potential origins for data packets based upon partial packet information.

11. A method for identifying a set of potential origins of Internet Protocol data packets on a network, said method comprising the steps of:
identifying a plurality of cooperating network locations, said cooperating locations providing information as to whether an identified data packet did or did not pass through said cooperating location at an identified point in time;
creating a link signature for each of said identified data packets, said link signature developed from information provided by said cooperating locations comprising a series of first predetermined values for each cooperating location through which said packet did pass and a series of second predetermined values for each cooperating location through which said packet did not pass;
developing a table of origins, said table comprising identified destination locations, unions of all link signatures matching partial data packet information available for said identified data packets and origin locations consistent with said link signatures; and
whereby, when a system user supplies a destination location and partial data packet information regarding an identified data packet, said system will identify the set of possible origins for said data packet.

12. The method for identifying a set of potential origins of Internet Protocol data packets on a network, as described in claim 11, comprising the further steps of:
dividing locations into blocks, where such blocks comprise locations that have identical link signatures for routing a packet to any location from another identified block at said identified point in time;
creating a reverse routing table, said table comprising link signatures identifying at least one valid routing between selected locations in each destination/source pair of blocks in said network for said identified point in time; and
whereby, when said locations in said network are divided into said blocks, the set of possible origins of identified packets may be more easily determined for very large networks.

13. The method for identifying a set of potential origins of Internet Protocol data packets on a network, as described in claim 12, comprising the further step of:
developing a table of origins wherein said table of origins comprises blocks having identified destination locations within them, unions of all link signatures matching partial data packet information available for said identified data packet and origin locations consistent with said link signatures in said reverse routing table.

14. The method for identifying a set of potential origins of Internet Protocol data packets on a network, as described in claim 11, wherein said cooperating network locations comprise incoming links to routers or switches on said network.

15. The method for identifying a set of potential origins of Internet Protocol data packets on a network, as described in claim 11, wherein said first predetermined values are either of “1” and “true” and said second predetermined values are either of “0” and “false.”

16. The method for identifying a set of potential origins of Internet Protocol data packets on a network, as described in claim 11, comprising the further step of gathering and maintaining said link signature for each identified data packet over a period of time, thereby permitting historical inquiries of said system.

17. The method for identifying a set of potential origins of Internet Protocol data packets on a network, as described in claim 12, wherein said method of developing link signatures identifying all possible valid routings between a selected cooperating location in each destination/source pair of blocks in said network for said reverse routing table comprises the further steps of:
identifying a destination location in each block;
identifying a responding source location in each block;
sending a probe packet to responding locations in each of said source blocks causing said source blocks to send an identifiable response packet to each of said destination locations in said destination blocks;
creating a link signature for each for each destination/source pair of locations derived from information returned by said identifiable response to said probe packet;
making an assignment of each said derived link signatures as link signatures indicating valid routing for all destination locations within said block to all potential source locations within any other block; and
whereby, the link signature derived from said identifiable response to said probe packet is recognized as being one of those that could be observed for packets forwarded from said given source block to said given destination block at a given point in time.

18. The method for identifying a set of potential origins of Internet data packets on a network, as described in claim 12, comprising the further steps of gathering and maintaining said link signatures in said reverse routing table over a period of time, thereby permitting historical inquiries of said table.

19. The method for identifying a set of potential origins of Internet Protocol data packets on a network, as described in claim 12, comprising the further step of updating definitions of said blocks as new link signature information related to cooperating locations within said blocks is received, thereby maintaining said blocks as groups of locations having identical link signatures for routing a packet to an identified location at said identified point in time.

20. The method for identifying a set of potential origins of Internet Protocol data packets on a network, as described in claim 11, comprising the further step of collecting and storing information at cooperating locations related to data packets passing through said cooperating locations over identified periods of time, said information comprising at least link signature and routing information related to said packets, thereby providing further means for identifying potential origins for data packets based upon partial packet information.
